(19) United States
(12) Patent Application Publication
(10) Pub. No.: US 2011/0191553 A1
(43) Pub. Date: Aug. 4, 2011

(54) Data Storage Control Apparatus and Data Storage Control Method

(76) Inventor: Satoshi Yamauchi, Tachikawa-shi (JP)

(21) Appl. No.: 13/086,190

(22) Filed: Apr. 13, 2011

Related U.S. Application Data
(63) Continuation of application No. 12/611,833, filed on Nov. 3, 2009.

(30) Foreign Application Priority Data
Feb. 19, 2009 (JP) 2009-036703

(51) Int. Cl. G06F 12/00; G06F 12/08

(52) U.S. Cl. 711/154; 711/E12.001; 711/E12.016

(57) ABSTRACT

According to one embodiment, a data storage control method, which is applied to a virtual memory that controls access to the data stored in each of the physical memory regions by the corresponding one of the virtual addresses on the basis of an address management table that manages the correspondence relationship between a plurality of virtual addresses corresponding to a plurality of virtual memory regions and a plurality of physical addresses corresponding to a plurality of physical memory regions of a first memory, includes writing the data stored in a specific number of nonconsecutive physical memory regions made to correspond to a specific number of virtual memory regions on the basis of the address management table to a specific number of consecutive physical memory regions.

### CROSS-REFERENCE TO RELATED APPLICATIONS

This application is a continuation application of U.S. patent application Ser. No. 12/611,833, filed Nov. 3, 2009, which is based upon and claims the benefit of priority from Japanese Patent Application No. 2009-036703, filed Feb. 19, 2009, the entire contents of which are incorporated herein by reference.

### BACKGROUND

1. Field

One embodiment of the invention relates to a data storage control apparatus and a data storage control method which use virtual storage.

2. Description of the Related Art

One typical device controlled by a central processing unit (CPU) and an operating system (OS) is a personal computer. With the recent popularization of digital video apparatuses, not only digital TVs but also hard disk recorders are controlled by a CPU and an OS.

The CPU expands the program stored in a nonvolatile memory, such as a NOR flash or mask ROM, to a volatile memory, such as a RAM, and executes the expanded program. The data expanded to a volatile memory, such as a RAM, will disappear when the power supply is stopped.

To overcome this problem, the OS and others have supported hibernation in recent years, preventing the data in the volatile memory from disappearing. That is, the hibernation function saves the work stored in the volatile memory in an external storage unit (or a hard disk) before the power supply is cut off and, when the power supply is resumed, returns the saved work to the volatile memory. This makes it possible to start the work again where it was interrupted.

When the hibernation function is performed, for example, all of the data stored in the volatile memory is saved in an external storage unit. As the capacity of the volatile memory is getting larger, the time required to transfer data from the volatile memory to the external storage unit tends to become longer. Jpn. Pat. Appln. KOKAI Publication No. 9-319667 has disclosed the technique for transferring only the data actually being used in the volatile memory to the external storage unit instead of directly transferring all of the data in the volatile memory to the external storage unit.

As described above, when only the data actually being used in the volatile memory is transferred to the external storage unit, the data stored in discontinuous regions often has to be transferred to the external storage unit. Handling the data stored in such discontinuous regions leads to a decrease in the processing efficiency and therefore an increase in the processing time.

For example, when the data in the volatile memory is compressed and then saved in the external storage unit, the compression efficiency of the data stored in discontinuous regions is lower than that of the data stored in a continuous region. Accordingly, data of a large size has to be transferred to an external storage unit, resulting in an increase in the processing time. Moreover, the external storage unit needs a sufficiently large amount of free space.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 schematically shows the configuration of a data storage control apparatus according to an embodiment of the invention;

FIG. 2 is a flowchart to explain a pause process to which a data continuation process has been applied in the embodiment;

FIG. 3 is a state transition diagram schematically showing a data continuation process in the embodiment;

FIG. 4 is a flowchart to explain a cancel process for cancelling a pause state transited in the pause process to which the data continuation process has been applied in the embodiment;

FIG. 5 is a flowchart to explain an example of the pause process to which the data continuation process has not been applied in the embodiment;

FIG. 6 is a diagram to explain a state before and that after the pause process to which the data continuation process has not been applied in the embodiment; and

FIG. 7 is a flowchart to explain a cancel process for cancelling a pause state transited in the pause process to which the data continuation process has not been applied in the embodiment.

### DETAILED DESCRIPTION

Various embodiments according to the invention will be described hereinafter with reference to the accompanying drawings. In general, a data storage control apparatus according to one embodiment of the invention comprises: a first memory configured to include a plurality of physical memory regions to which a plurality of physical addresses are made to correspond; and a controller configured to control access to the data stored in each of the physical memory regions by the corresponding one of the virtual addresses on the basis of an address management table that manages the correspondence relationship between a plurality of virtual addresses corresponding to a plurality of virtual memory regions and said plurality of physical addresses corresponding to said plurality of physical memory regions, wherein the controller is configured to write the data stored in a specific number of nonconsecutive physical memory regions made to correspond to a specific number of virtual memory regions on the basis of the address management table to a specific number of consecutive physical memory regions, manipulate the address management table to make the virtual addresses of the specific number of virtual memory regions to correspond to the physical addresses of the specific number of consecutive physical memory regions, compress the data written to the specific number of consecutive physical memory regions, write the compressed data to a save region of a second memory, and execute a data continuation process of managing the address of the save region of the second memory.

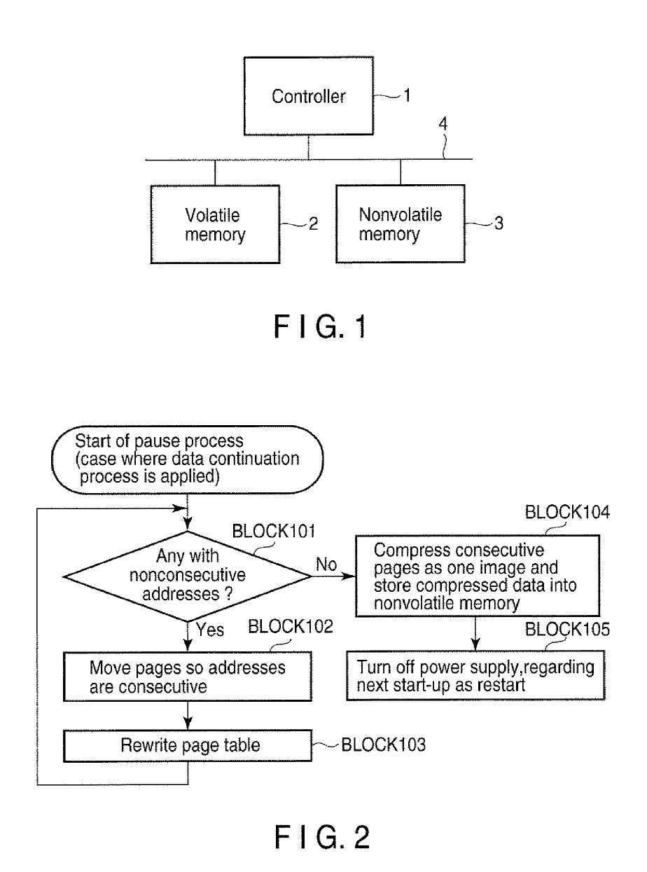

FIG. 1 schematically shows the configuration of a data storage control apparatus according to one embodiment of the invention. The data storage control apparatus can be applied to a personal computer, a digital TV, a hard disk recorder, or the like.

As shown in FIG. 1, the data storage control apparatus comprises a controller which can contain a CPU or the like, a volatile memory 2 which can be a RAM or the like, and a nonvolatile memory 3 which can be a NOR flash memory, a hard disk drive (HDD), or the like. The controller 1, volatile memory 2, and nonvolatile memory 3 are connected to one another via a bus 4. The volatile memory 2 includes a physical memory space. The physical memory space is composed of a plurality of physical pages (or a plurality of physical memory regions). A plurality of physical pages correspond to a plurality of physical addresses. That is, each physical page can be managed by each physical address.

The controller 1, in cooperation with the OS, controls the reading and writing of data using a virtual memory space. The virtual memory space is composed of a plurality of virtual pages (or a plurality of virtual memory regions). A plurality of virtual pages correspond to a plurality of virtual addresses. That is, each virtual page can be managed by each virtual address. For example, the controller 1 creates a page table (or an address management table) which manages the correspondence relationship between a plurality of virtual addresses and a plurality of physical addresses. On the basis of the page table, the controller 1 controls access to the data stored in each physical page using the corresponding one of the virtual addresses. That is, access to the data is controlled in pages.

Next, suspend resume and hibernation will be explained. When suspend resume is executed, the power supply to the nonvolatile memory is continued, whereas the power supply to the components excluding the nonvolatile memory is stopped. Since the data in the nonvolatile memory is held while the suspend resume is being executed, when the suspend resume is cancelled, the work can be resumed at high speed where it was interrupted on the basis to the data stored in the nonvolatile memory.

Hibernation is executed before the power supply is stopped. When hibernation has been executed, the memory image in the volatile memory is stored in the nonvolatile memory. When the power supply is started again, the work can be started again where it was interrupted on the basis of the memory image stored in the nonvolatile memory.

When the suspend resume is being executed, the memory region has to be refreshed by constantly supplying power to the nonvolatile memory. Therefore, the standby power consumption in suspend resume is higher than that in hibernation. On the other hand, when hibernation has been executed, the data in the volatile memory is saved in the nonvolatile memory. To start the work again, the data saved in the nonvolatile memory has to be read into the volatile memory. Consequently, the waiting time until the work is started again by hibernation becomes longer than the waiting time until the work is started again by suspend resume.

Furthermore, when hibernation is executed, it is conceivable that the data in the volatile memory is compressed and the compressed data is saved in the nonvolatile memory. Moreover, to improve efficiency, it is conceivable that only the data in the addresses being used in the volatile memory is compressed as an image and the compressed data is saved in the nonvolatile memory.

In general, if the unit of data to be compressed is large, the data compression ratio is high and the data size after compression becomes small. If the unit of data to be compressed is small, the data compression ratio is low and the data size after compression does not become so small.

As described above, when only the data in the addresses being used is compressed as an image and the compressed data is stored, the continuity of the addresses being used is not guaranteed. The individual data items in nonconsecutive addresses are compressed separately. That is, the unit of data to be compressed tends to become smaller. Accordingly, the compression ratio decreases and therefore the data size after compression does not become so small. Moreover, nonconsecutive addresses need complicated management. In addition, when the work is started again, the process of writing expanded data to the individual pages in nonconsecutive addresses is needed, which complicates the processes.

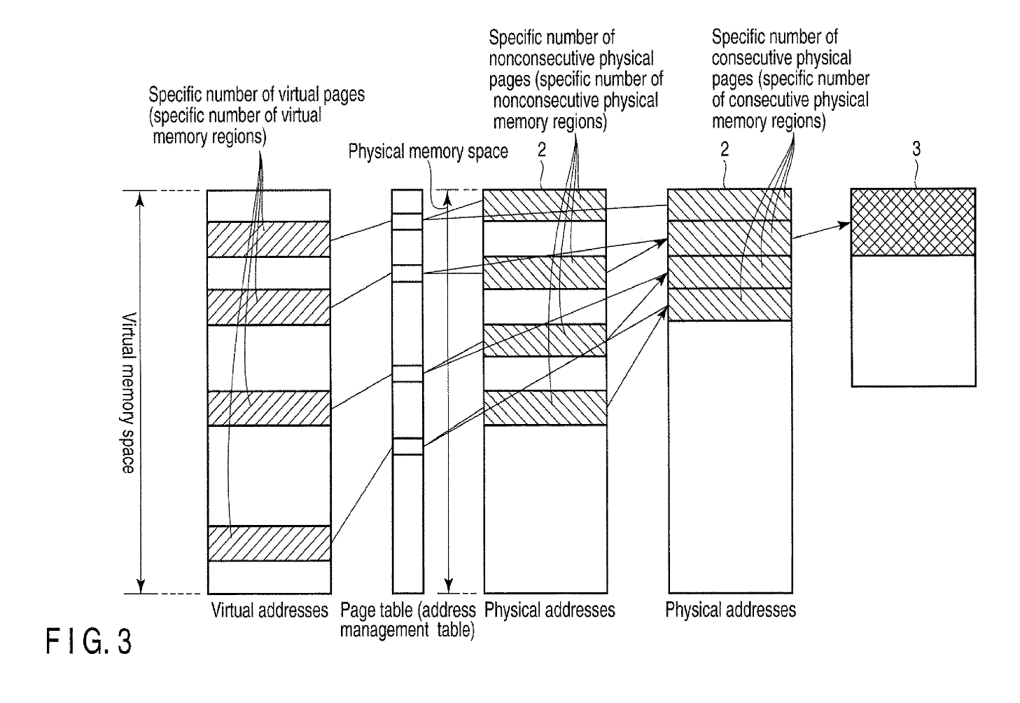

To overcome this problem, the controller 1 of the data storage control apparatus executes a data continuation process (explained below) in a pause process for transiting to a pause state as shown in FIG. 3. Specifically, on the basis of the page table, the controller 1 writes the data items stored in a specific number (e.g., n, where n is an integer greater than 1) of nonconsecutive physical pages made to correspond to a specific number (e.g., n, where n is an integer greater than 1) of virtual pages to a specific number (e.g., n, where n is an integer greater than 1) of consecutive physical pages. Moreover, on the basis of the page table, the controller 1 makes the virtual addresses of a specific number of virtual pages correspond to the physical addresses of a specific number of consecutive physical pages. In addition, the controller 1 compresses the data written to the specific number of consecutive physical pages and writes the compressed data to save regions of the nonvolatile memory 3 and manages the addresses of the save regions. That is, the controller 1 makes the individual addresses of a specific number (e.g., n, where n is an integer greater than 1) of consecutive physical pages correspond to the individual addresses of the save regions.

Here, a state before a pause process is compared with a state after the pause process with reference to FIG. 3. Before the pause process is started, data items being used exist in nonconsecutive virtual pages in the virtual memory space. Similarly, data items being used exist in nonconsecutive physical pages even in the physical memory space. At this time, the page table makes the individual virtual addresses of the nonconsecutive virtual pages correspond to the individual physical addresses of the nonconsecutive physical pages. In contrast, after the pause process, although the data items being used exist in the nonconsecutive virtual pages in the virtual memory space, the data items being used exist collectively in the consecutive physical pages in the physical memory space. At this time, the page table makes the individual virtual addresses of the nonconsecutive virtual pages correspond to the physical addresses of the consecutive physical pages.

Specifically, in the pause process, the data items stored in the nonconsecutive physical pages being used are written to consecutive physical pages. In parallel with this, the page table is updated, the data items in the consecutive physical pages are compressed as one image, and the compressed data is written to the save regions of the nonvolatile memory 3. Accordingly, the unit of data to be compressed can be made larger, increasing the compression ratio, which enables the data size after compression to be made smaller. In addition, since the compressed data can be expanded in one place (a specific number of consecutive physical pages), address management becomes simpler and the expansion time becomes shorter. Since the page table has been updated before the pause, it is possible to access the data immediately on the basis of the page table when the work is started again. In addition, since the individual virtual addresses of the specific number of virtual pages in the page table are not updated, the load in starting the work again is low.

FIG. 2 is a flowchart to explain a pause process for transiting to a pause state in the embodiment. The controller 1 searches a plurality of physical pages being used for physical pages whose physical addresses are nonconsecutive (BLOCK 101). If there are physical pages whose physical addresses are nonconsecutive (YES in BLOCK 101), the controller 1 moves the physical pages so that the physical addresses may be consecutive (BLOCK 102). That is, the controller 1 writes the data in the nonconsecutive physical pages to consecutive physical pages. In response to this, the controller 1 rewrites the page table (BLOCK 103). If physical pages whose physical addresses are nonconsecutive disappear (NO in BLOCK 101), the controller 1 compresses the data in the consecutive physical pages as one image, stores the compressed data in the save region of the nonvolatile memory 3 (BLOCK 104), manages the addresses of the save regions, and stops the power supply.

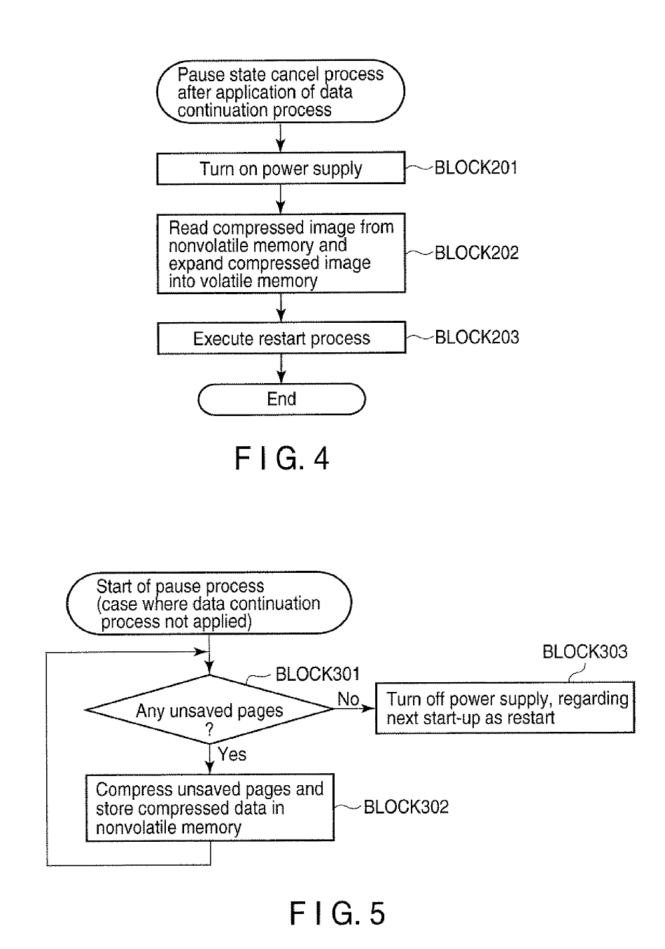

FIG. 4 is a flowchart to explain a cancel process for cancelling a pause state in the embodiment. When the power supply is started again (BLOCK 201), the controller 1 reads the compressed data from the save regions of the nonvolatile memory 3 on the basis of the addresses of the save regions of the nonvolatile memory 3 and expands the compressed data into the consecutive physical pages according to a save table which makes the individual addresses of the consecutive physical pages correspond to the individual addresses of the save regions (BLOCK 202). The controller 1 restarts the work on the basis of the expanded data (BLOCK 203).

FIG. 5 is a flowchart to explain an example of the pause process to which the data continuation process has not been applied in the embodiment. In the pause process, a plurality of physical pages being used are searched for physical pages in which unsaved data has been stored (BLOCK 301). If there are physical pages in which unsaved data has been stored (YES in BLOCK 301), the unsaved data stored in the physical pages is compressed. That is, the data is compressed in pages. The compressed data is saved in the save regions of the nonvolatile memory (BLOCK 302). The addresses of the unsaved physical pages are made to correspond to the addresses of the save regions in the save table. On the basis of the save table, the correspondence between the addresses of the physical pages and the addresses of the save regions is managed.

The search of physical pages, the compression of unsaved data in pages, the storage of the compressed data, and the management of addresses are repeated as described above until physical pages in which unsaved data has been stored have disappeared. When physical pages in which unsaved data has been stored have disappeared, the power supply is stopped (BLOCK 303).

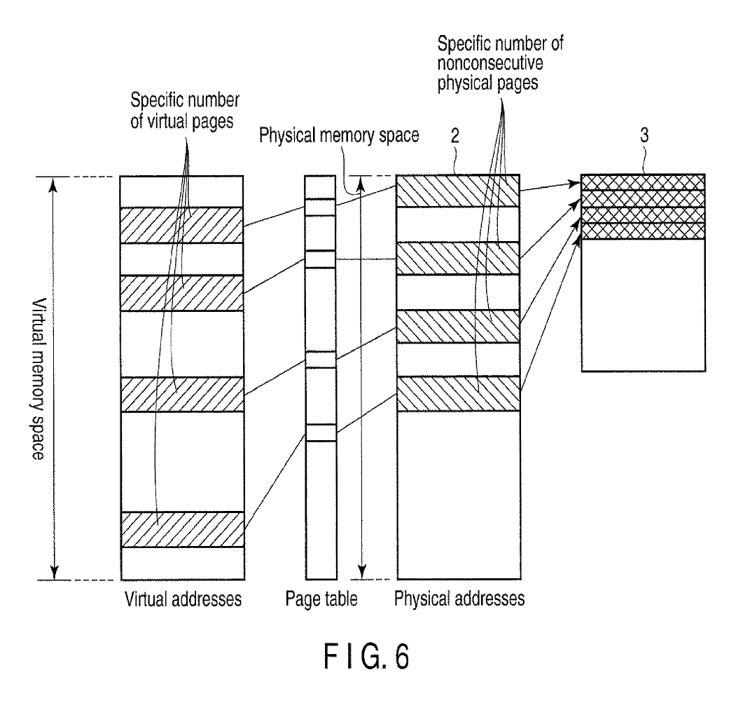

FIG. 6 is a diagram to explain a state before and that after a pause process to which the data continuation process has not been applied in the embodiment. Before a pause process is started, data being used exists in nonconsecutive virtual pages in the virtual memory space. Similarly, data being used exists in nonconsecutive physical pages even in the physical memory space. At this time, the page table makes the individual virtual addresses of the nonconsecutive virtual pages correspond to the physical addresses of the nonconsecutive physical pages.

After the pause process (or in the pause state), the page table remains unchanged and the data items stored in the nonconsecutive physical pages are compressed and the compressed data items are stored in the individual save regions of the nonvolatile memory. That is, the page table makes the individual virtual addresses of the nonconsecutive virtual pages correspond to the individual physical addresses of the nonconsecutive physical pages and manages the correspondence between the virtual addresses and the physical addresses. Moreover, a save table makes the physical addresses of the nonconsecutive physical pages correspond to the addresses of the individual save regions of the nonvolatile memory and manages the correspondence between the physical addresses and the addresses of the save regions.

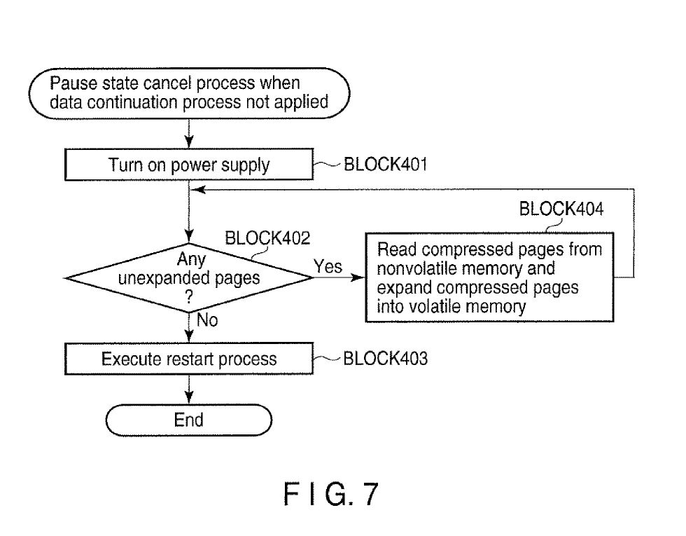

FIG. 7 is a flowchart to explain a cancel process for cancelling a pause state transited in the pause process to which the data continuation process has not been applied. When the power supply is started again (BLOCK 401), the compressed data items are read from the individual save regions of the nonvolatile memory according to the save table and then the individual compressed data items are expanded into the nonconsecutive physical pages (BLOCKS 402 and 404). Since the compressed data has to be expanded into each of the nonconsecutive physical pages, the work of reading the compressed data from one save region and expanding the compressed data into one physical page has to be repeated, which makes the working efficiency worse. The reading and expansion of the compressed data are continued until the data to be expanded has run out. If the data to be expanded has run out (NO in BLOCK 402), a work resumption process is carried out on the basis of the expanded data (BLOCK 403). Since the work resumption process has to be executed on the basis of the data expanded to the nonconsecutive physical pages, the efficiency of the work resumption process is poor.

While in the explanation, the data in the volatile memory has been compressed and stored in the nonvolatile memory, the data may be stored in the nonvolatile memory without compressing the data. In this case, too, use of the data continuation process enables the data stored in the nonvolatile memory to be written to a continuous region of the volatile memory, which makes the working efficiency high. For the same reason, the efficiency of the work resumption process is also high, making it possible to shorten the time required for the work resumption process.

While in the data continuation process, the data items in the nonconsecutive physical pages have been written to the consecutive physical pages, a data virtual continuation process of not writing the data items to consecutive physical pages may be used.

The data virtual continuation process is as follows. In the above explanation, the page table (hereinafter, referred to as page table A) manages the correspondence between a plurality of virtual addresses in the virtual memory space (hereinafter, referred to as virtual memory space A) and a plurality of physical addresses in the physical memory space of the nonvolatile memory 3. In addition to page table A, page table B is used. Page table B makes the individual physical addresses of the nonconsecutive physical pages being used in the nonvolatile memory 3 correspond to the individual virtual addresses of the consecutive virtual pages in a virtual memory space B. Then, using the consecutive virtual pages in the virtual memory space B, an image of the data items stored in the nonconsecutive physical pages being used in the nonvolatile memory 3. When the work is stared again, the image created on the consecutive virtual pages in the virtual memory space B is returned to the original. Furthermore, on the basis of the page table A, the resulting data items are returned to the virtual memory space A. By doing this, the processing efficiency can be raised by a virtual continuation process without physically moving the data.

By the data continuation process and data virtual continuation process explained in the embodiment, the efficiency of a process, such as hibernation, can be improved. That is, by the high compression of data and the simplification of a resumption process, such a process as hibernation can be made more efficient. As a result, the time required for the work resumption process can be shortened. The data continuation process and data virtual continuation process explained in the embodiment do not require an operation program for a process, such as hibernation.

Hereinafter, the embodiment is summarized as follows:

(1) Move the data items in nonconsecutive pages of the nonvolatile memory to consecutive pages of the nonvolatile memory before the transition to a pause state.

(2) Rewrite the page table after the move.

(3) Compress the data in consecutive pages as one image instead of compressing the data in pages, which increases the compression ratio.

(4) When the work is started again, the compressed data items are expanded collectively to consecutive pages instead of expanding the data to nonconsecutive pages separately. Since one image is expanded to a series of consecutive pages, the expansion process becomes faster.

(5) Since the work is started again on the basis of the data expanded to a series of consecutive pages instead of restarting the work on the basis of the data expanded separately to nonconsecutive pages, the efficiency of the work resumption process is high.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data storage control apparatus comprising:
a first memory configured to include a plurality of physical memory regions to which a plurality of physical addresses are made to correspond; and
a controller configured to control access to the data stored in each of the physical memory regions by a corresponding virtual address for a given physical address on the basis of an address management table that manages the correspondence relationship between a plurality of virtual addresses corresponding to a plurality of virtual memory regions and said plurality of physical addresses corresponding to said plurality of physical memory regions,
wherein the controller is configured to write the data stored in a specific number of nonconsecutive physical memory regions included in the first memory and made to correspond to a specific number of virtual memory regions on the basis of the address management table to a specific number of consecutive physical memory regions included in the first memory, manipulate the address management table to make the virtual addresses of the specific number of virtual memory regions correspond to the physical addresses of the specific number of consecutive physical memory regions, compress the data written to the specific number of consecutive physical memory regions, write the compressed data to a save region of a second memory, and execute a data continuation process of managing the address of the save region of the second memory,
the controller is configured to execute the data continuation process in one pause process for transitioning to a pause state.

2. The apparatus of claim 1, wherein the first memory is composed of a volatile memory,
the second memory is composed of a nonvolatile memory, and
the controller is configured to write the data being used stored in the specific number of nonconsecutive physical memory regions to the specific number of consecutive physical memory regions.

3. The apparatus of claim 1, wherein the controller is configured to expand the compressed data in the save region of the second memory into the specific number of consecutive physical memory regions in a cancel process of cancelling the pause state.

4. A data storage control method which is applied to a virtual memory that controls access to the data stored in each of the physical memory regions by a corresponding virtual address for a given physical address on the basis of an address management table that manages the correspondence relationship between a plurality of virtual addresses corresponding to a plurality of virtual memory regions and a plurality of physical addresses corresponding to a plurality of physical memory regions of a first memory, the data storage control method comprising:
writing the data stored in a specific number of nonconsecutive physical memory regions included in the first memory and made to correspond to a specific number of virtual memory regions on the basis of the address management table to a specific number of consecutive physical memory regions included in the first memory;
manipulating the address management table to make the virtual addresses of the specific number of virtual memory regions correspond to the physical addresses of the specific number of consecutive physical memory regions;
compressing the data written to the specific number of consecutive physical memory regions;
writing the compressed data to a save region of a second memory; and
executing a data continuation process of managing the address of the save region of the second memory in one pause process for transitioning to a pause state.

5. The method of claim 4, further comprising: writing the data stored in the specific number of nonconsecutive physical memory regions to the specific number of consecutive physical memory regions.

6. The method of claim 4, further comprising: expanding the compressed data in the save region of the second memory into the specific number of consecutive physical regions in a cancel process of cancelling a pause state.

7. An apparatus comprising:
a first memory configured to include a plurality of physical memory regions each corresponding to one of a plurality of physical addresses;
a second memory; and
a controller configured to control access to data stored in one of the plurality of physical memory regions via a virtual address corresponding to a physical address corresponding to the one of the plurality of physical memory regions, the controller being configured to (i) write the data stored in a specific number of nonconsecutive physical memory regions of the plurality of physical memory regions included in the first memory to a specific number of consecutive physical memory regions included in the first memory, (ii) correspond a specific number of the plurality of virtual memory regions to the specific number of consecutive physical memory regions, (iii) compress the data written to the specific number of consecutive physical memory regions, write the compressed data to a save region of the second memory, (iv) managing an address of the save region of the second memory, and (v) transitioning to a pause state.

8. The apparatus of claim 7, wherein the first memory is composed of a volatile memory.

9. The apparatus of claim 7, wherein the second memory is composed of a nonvolatile memory.

10. The apparatus of claim 7, wherein the controller is configured to expand the compressed data in the save region of the second memory into the specific number of consecutive physical memory regions in exiting from the pause state.
